(19) United States
(12) Patent Application Publication
(10) Pub. No.: US 2025/0314488 A1
(43) Pub. Date: Oct. 9, 2025

(54) RADAR MEASURING METHOD AND RADAR MEASURING DEVICE FOR MEASURING A TUBULAR MEASURED OBJECT

(71) Applicant: CiTEX Holding GmbH, Melle (DE)

(72) Inventor: Arno Neumeister, Porta Westfalica (DE)

(73) Assignee: CiTEX Holding GmbH, Melle (DE)

(21) Appl. No.: 19/098,920

(22) Filed: Apr. 2, 2025

(30) Foreign Application Priority Data
Apr. 4, 2024 (DE) 10 2024 109 459.1

(51) Int. Cl. G01B 15/02

(52) U.S. Cl. CPC G01B 15/02

(57) ABSTRACT

Measuring a tubular measured object, in particular, following its extrusion, may include (1) guiding the tubular measured object in an object adjusting direction through a measuring space between a radar transceiver and a reflector, (2) emitting a radar transmitting beam from the radar transceiver along its optical axis in a transverse direction through the measuring space towards a reflector and back towards the radar transceiver, while determining an empty time of flight, (3) adjusting the radar transceiver in an adjusting direction (y) which preferably runs perpendicular to the transverse direction (x), and emitting and receiving the radar transmitting beams at various adjustment positions, (4) upon detecting a measurement signal (a) measuring the adjustment position (ys) and the time-of-flight shift, (b) measuring an external radius (r) of the tubular measured object, and, (c) determining the refractive index (n) of the tubular measured object from the values recorded.

This application claims priority of German Application No. 10 2024 109 459.1, filed Apr. 4, 2024, which is hereby incorporated herein by reference in its entirety.

The invention relates to a radar measuring method and a radar measuring device for measuring a tubular measured object, in particular, after the extrusion of the tubular measured object.

Pipes made of plastics or rubber are usually measured after being extruded to examine their geometric properties, i.e., in particular, exterior diameter, interior diameter and wall thicknesses. In the case of radar measuring methods or, respectively, THz measuring methods, usually, a pipe is guided through a measuring space, where a radar transceiver emits a radar transmitting beam perpendicular through the center point of the pipe so that partial reflections of the radar transmitting beam happen on the exterior surface and interior surface thereof, and the so reflected radar beams can be detected with their times of flight. Thus, given a known refractive index of the material, a determination of the relevant geometric properties of the exterior diameter, interior diameter and wall thicknesses can be made directly from a radar measurement through the center point of the pipe.

Generally, the refractive index of the material is unknown initially, since it may depend on its exact composition as well as, e.g., the temperature. As the speed of light of the radar radiation inside the pipe is determined by the refractive index, it follows that initially the geometric properties cannot be clearly determined while the refractive index remains unknown.

The document WO 2016/139155 A1 describes a measuring method, where initially an empty measurement without any measured object is carried out, where a Terahertz transceiver utilizes radiation through the empty measurement space towards a reflector and back to the THz transceiver. In the subsequent measurement of the measured object a total time-of-flight delay of the total reflection peaks compared to the empty measurement is determined, together with the times of flight of the partial reflection peaks on the boundary surfaces of the pipe. Thereafter, the refractive index and wall thicknesses or, respectively, geometric properties are determined from these measurements.

Often, however, particularly the inner surfaces are slightly deformed, e.g., caused by sagging, where soft raw material trickles down on the interior surface, so that there will be no exact partial reflection along the optical axis back to the THz transceiver, whereby this measuring method cannot be executed even if one partial reflection peak is missing. Furthermore, the method of WO 2016/139155 A1 requires a special mirror arrangement and focusing of the THz radiation, where errors may occur in the event of eccentricity of positions of the pipe. Moreover, the attenuation of the radar measuring signal in the measurement may be significant, where, in particular, there may occur absorption of the radar beams in the material of the pipe, and, e.g., slight misalignments of the surfaces additionally reflect part of the partial reflections away unfavorably so that in the measurement sometimes only the total reflection peak of the radar transmitting beams can be determined at the reflector, while it is no longer possible to exactly determine all partial reflection peaks.

The citation DE 10 2016 105 599 A1 describes a Terahertz measuring device for measuring a test object, in particular, a pipe, where the Terahertz measuring device comprises a THz transmitter and receiver unit of emitting THz radiation in a emission spatial angle along an optical axis, receiving reflected THz radiation, and generating a signal amplitude as a function of time or frequency, as well as a controller and evaluator unit for receiving and evaluating the signal amplitude, the controller and evaluator unit determining faults in the test object from the signal amplitude, in particular, based on reflected Terahertz radiation that was reflected non-perpendicularly on proper boundary surface of the test object. Hereby, in particular, a screen is provided positioned in the optical axis for hiding a core area of the emission spatial angle about the optical axis.

The subsequently published document DE 10 2023 108 276 A1 describes a THz measuring method and a THz measuring device for measuring a profile, in particular, of an extruded pipe, in a measuring space, wherein a THz measuring unit including a THz transceiver with an optical axis and preferably an opposite reflector rotates or reverses around a measuring space and THz measurements are carried out in two opposite measuring positions. Hereby, THz measuring beams are emitted along the optical axis of the THz transceiver, and reflected THz radiation is detected containing respective facing reflection peaks facing wall region and averted reflection peaks of the averted wall region as well as preferably a total reflection peak, where the layer thickness of the strand is determined.

The citation DE 197 57 067 A1 describes a method for measuring the diameter of a strand, in particular, a smaller diameter cable, where the strand without any intermediate imaging optics is illuminated by means of the light of at least one monochromatic light source that is punctiform in the measuring plane, the direction of the main beam is approximately perpendicular to the longitudinal axis of the strand, and light is received without intermediate imaging optical elements at a single- or multiline light-sensitive sensor a the opposite side of the strand, where the axis of the sensor is approximately perpendicular to the main beam axis. The results are used to determine a value representing the strand diameter by evaluating the progressions of intensity in the diffraction spaces at the edges of the shadow caused by the strand.

Thus, it is the object of the invention to create a radar measuring method and a radar measuring device for measuring a tubular measured object allowing for a secure measuring of the measured object.

This task is solved by a radar measuring method and a radar measuring device according to the independent claims. Preferred further developments are described in the sub-claims.

The radar measuring method according to the invention may, in particular, by carried out using a radar measuring device according to the invention.

Underlying the invention is the idea to adjust the radar transceiver during the measuring process in a defined way, in particular, in a vertical direction orthogonal to its optical axis, and to carry out measurements in each of the vertical positions, wherein the radar transmitting beam is emitted and the reflected radar beam is detected. By virtue of the vertical adjustment of the radar transceiver it is possible to continuously carry out an empty measurement in that the radar transceiver is guided up to positions above or below the measured object. Hereby, according to the invention, it was determined that in the course of the adjustment of the radar transceiver along the measured object in some positions, in particular, each in a position between the middle and an upper position, a total reflection peak without additional partial reflection peaks is determined at the boundary surfaces of the measured object. The invention recognizes the fact that, subsequently, the refractive index of the tubular measured object or, respectively, pipe, can be determined from the time of flight delay and the determined measuring position.

Thus, the invention advantageously allows for a determination of the refractive index without determining partial reflection peaks at boundary surfaces in that in the course of the measurement a special beam geometry is recognized which can already be directly evaluated with the measuring signals and measured values. Since no partial reflection peaks occur in the course of the measurement, the strong signal of the total reflection peaks can be securely detected, and even deformation of the interior surface does not lead to an attenuation of the result. Hereby, it is apparent that, in particular, the exterior contours of the measured object is generally sufficiently securely determined upon extrusion and no deformation like sagging etc. will occur on the exterior surfaces which cool off faster than the interior surfaces.

The invention advantageously exploits the fact that the refractive index of the pipe has two effects on the characteristics of the beam geometry:
Firstly, an optical refraction of the radar measuring beam occurs upon entry into the exterior surface of the pipe, and, thereafter, accordingly upon exit from the pipe into the anterior region towards the reflector, where according to the law of refraction the entrance angle and the exit angle of both refractions on the boundary surfaces directly depend upon the refractive index.
Secondly, the time of flight of the radar transmitting beams between the entry point into the pipe and the exit point from the pipe directly depends on the speed of light in the material and thereby directly on the refractive index so that the time-of-flight delay of the radar transmitting beams through the pipe, given a fixed geometric beam path, can be associated with this distance.

The invention advantageously achieves a defined geometric structure in that it is determined already upon receiving a reflected radar beam that the radar transmitting beam, which has passed through the pipe and exists again at its rear region, will impinge upon the reflector perpendicularly, because no other reflected radar beam can be received. Thus, when detecting a radar beam with a partial reflection peak, the corresponding geometric structure can be applied where, thus, some variables are known already, since for one thing the time-of-flight delay compared to the empty measurement and also the vertical position of the radar transceivers can be measured directly. Moreover, e.g., the external radius of the pipe can be determined directly; often, the external radius of the pipe is known already, e.g., from previously made mechanical measurements; furthermore, the external radius may also be determined, e.g., by means of a laser, another optical device and/or, e.g., ultrasound; furthermore, however, the external radius may be determined from the measurements themselves, because the radar transceiver is guided in its adjusting direction across the pipe thereby allowing the position of the outside circumference directly as shading of the radar transmitting beams.

Thus, it is possible, in particular, in the vertical adjustment
to detect the entry of the radar transmitting beams into the pipe detected,
in a subsequent adjustment of the radar transceivers towards the middle, subsequently to determine the radar measuring position while determining the delayed total reflection peaks, and
subsequently carry out a further adjustment towards the middle, where the middle position through the center of the pipe can be detected directly as a measurement of the total reflection peaks, in particular, with the partial reflection peaks, where the middle position can also be detected when, e.g., an interior surface does not re-reflect precisely, and
in a further vertical adjustment, e.g., further downwards, it can be determined again that the external radius has been reached.

Hereby, measurements are provided, in particular, in special positions.

In a first elevated position the radar transmitting beam travels through the wall of the measured object without being reflected at an interior surface, reaches an exit point which is different from the entry point, from where the radar transmitting beam then perpendicularly impinges upon the reflector and is reflected back.

According to a further, alternative or, in particular, even additional, in particular, subsequent measurement, the radar transmitting beam travels through the wall of the measured object, is subsequently reflected at an interior surface, and further reaches an exit point which is different from the entry point, from where the radar transmitting beam perpendicularly impinges upon the reflector and is reflected back. Hereby, in particular, a symmetric optical formation around the reflection point at the interior surface may result.

According to a further preferred embodiment, a picoting of the radar transmitting beams happens, in particular, by swiveling the radar transceiver. Preferably, an opposite reflector is also swiveled. Here, again an identical or similar geometry to that of the translational adjustment may be utilized. In addition, also partial reflections on boundary surfaces like the exterior surface and/or interior surface can be measured.

Advantageously, the invention may also provide for a subsequent measurement to be carried out, e.g., in the case of a missing interior reflection peak on an interior surface, because, with a known refractive index, the position of the wall surface and the corresponding layer thicknesses can be estimated on the basis of the empty measurement and the transmission measurement even in the event of a missing reflection on a boundary surface, in particular, in accordance with the method of DE 10 2020 120 547 A1. Thus, the refractive index determination without utilization of partial reflection peaks allows for a subsequent determination of wall thicknesses with boundary surfaces that supply no partial reflection peak.

The measuring device according to the invention and the measuring method according to the invention further allow for measuring without a cross table or a similar means laboriously adapting the position of the radar measuring device, because by virtue of the continuous vertical adjustment of the radar transceiver the relevant measuring zone is always covered and the position of the pipe is always detected, even in the case of an adjustment of the pipe. Thus, the warm pipe may, e.g., deviate from the axis of geometry of the measuring device, where, according to the invention, further measurements are still possible because the vertical guiding of the transceiver always timely covers the pipe and adjacent free regions.

In determining the refractive index, in particular, a calculation may be carried out on the basis of the existing shapes, e.g., with a subsequent power series approximation of the so generated formulae.

The optical measurement may be carried out, in particular, using a laser

The radar transmitting beam may be emitted, in particular, in a frequency range between 10 GHz and 50 THz, in particular, 10 GHz and 10 THz, in particular, 20 GHz or 50 GHz and 3 THz

According to a preferred embodiment, it is provided that the external radius can be determined in accordance with one or more of the following measuring method(s):
mechanical measurement,
optical measurement,
ultrasound,
additional radar sensors in another geometric arrangement, e.g., vertical to the optical axis,
adjustment of the radar transceiver in the vertical direction while receiving the des measuring signal, where the external radius is determined as the vertical distance according to one or more of the following measuring method(s):
between an upper outer point at the upper edge of the tubular measured object and the opposite lower outer point and/or
between a middle point at which the radar transmitting beam passes perpendicularly through the exterior surface and interior surface of the tubular measured object and one of the outer points.

According to a preferred embodiment, it is provided that the radar transceiver, in particular, can be adjusted on a guide means continuously in the adjusting direction, in particular, reversed or rotated

The method for measuring a tubular measured object according to the invention may, in particular, be carried out in the course of extrusion of the tubular measured object.

According to a preferred embodiment, it is provided that the adjusting direction of the radar transceiver is linear, in particular, perpendicular to the object adjusting direction and/or to an optical axis of the radar transceiver.

According to a preferred embodiment, it is provided that the adjustment of the radar transceiver is at least in part a pivoting adjustment, in particular, at a swing angle (p) perpendicular to the object adjusting direction.

According to a preferred embodiment, it is provided that a position of the radar transceiver is assumed and measured in which the radar transmitting beam passes at an entry point through an exterior surface of the measured object, with subsequent reflection, in particular, total reflection on an interior surface and subsequent passage through an exit point towards the reflector, while detecting a total reflection peak, in particular, with symmetric formation of the beam path after reflection on the interior surface.

The invention is further illustrated below by means of the accompanying drawings by means of a few embodiments. It is shown in:

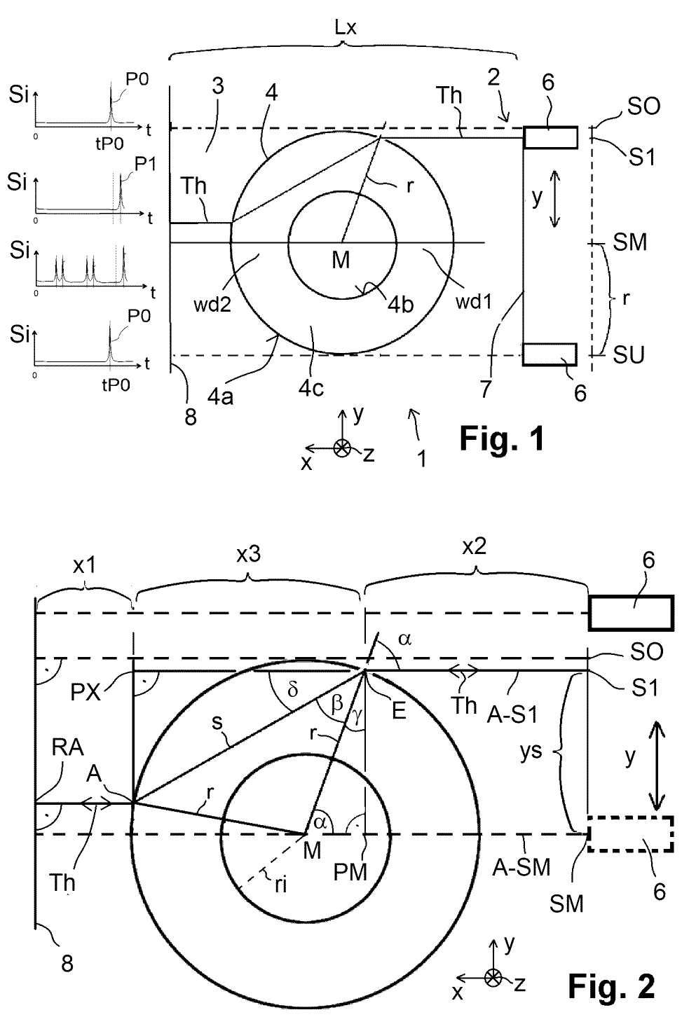

FIG. 1 a measuring arrangement for measuring a pipe with multiple measuring positions and measuring signals according to one embodiment;

FIG. 2 a representation corresponding to that of FIG. 1 with specifications of geometric variables in the beam path;

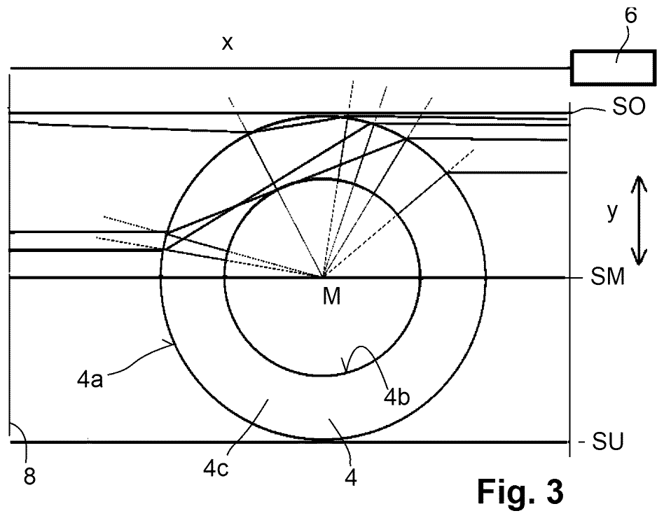

FIG. 3 multiple beam paths upon vertical adjustment of the radar transceiver;

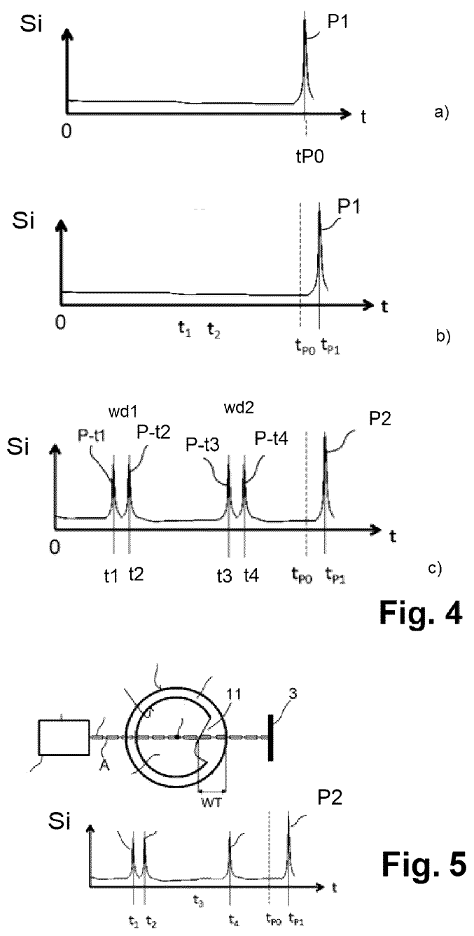

FIG. 4 measuring diagrams in multiple vertical positions;

FIG. 5 a measurement in a case of a missing partial reflection peak;

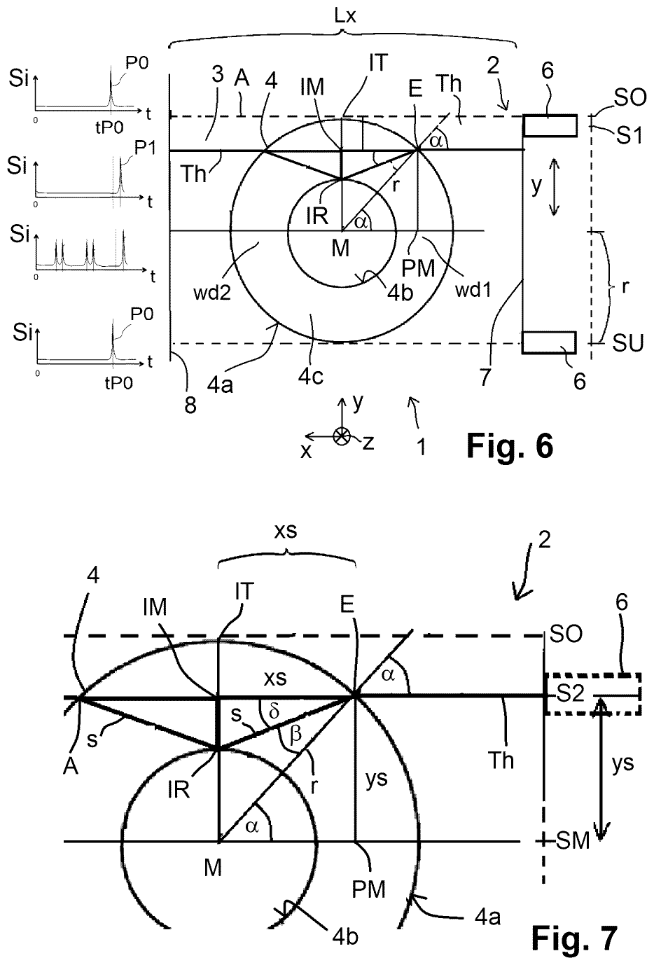

FIG. 6 a measuring arrangement for measuring a pipe in a measuring position according to further embodiments;

FIG. 7 a blow up of the arrangement of FIG. 6;

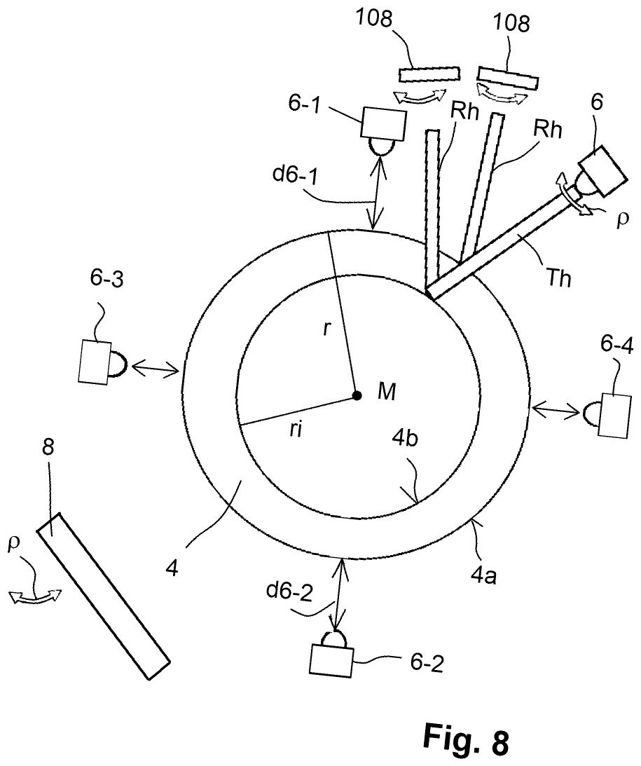

FIG. 8 a measuring arrangement for measuring a pipe according to a further embodiment with pivoting of the radar transceiver.

FIG. 1 shows a radar measuring arrangement 1 including a radar measuring device 2 with a measuring space 3 as well as a measured object 4 received inside the measuring space 3. The measured object 4 is designed as a pipe preferably pulled along its axis of symmetry in the z direction through the measuring space 3 and continuously measured. To that end, the radar measuring device 2 comprises a radar transceiver 6 which is adjusted in a vertical direction y at a guide means 7, and a reflector 8 disposed opposite in the measuring space 3. The reflector 8 may continuously extend across the entire height y of the measuring space 3, or it may be adjusted together with the opposite radar transceiver 6 in the vertical direction y. The radar transceiver 6 emits a radar transmitting beam Th along its optical axis A6 which runs, in this embodiment, in the x direction, i.e., perpendicular to the vertical direction y and perpendicular to the object adjusting direction z or, respectively, transport direction z of the pipe 4. Thus, a measuring plane is spread out as xy plane, corresponding to the drawing plane of the FIGS. 1 and 2, where the pipe 4 is preferably adjusted in the object adjusting direction z perpendicular through the xy plane and continuously measured, in particular, following its extrusion.

The Rohr 4 has a ring-shaped cross-section with a cylindrical exterior surface 4a, a cylindrical interior surface 4b and a wall 4c formed between the interior surface 4b and the exterior surface 4a which is made from a plastics material with a refractive index n, where the refractive index n may be, e.g., in the range of 1.3 to 1.7. To be included in the measurement, shall be, in particular, a determination of both its geometric properties, i.e., in particular, its external radius r, i.e., the distance of the exterior surface 4a to its center point M, as well as its internal radius ri, and further the refractive index n.

The measurement is carried out while adjusting the radar transceiver 6 in vertical direction y including measuring a time of flight of the radar transmitting beam Th from the transceiver 6 to the reflector 8 and back to the radar transceiver 6. The time-of-flight measurement may be carried out, in particular, using frequency modulation, e.g., as FMCW (frequency modulated continuous wave) radar, or also by pulsed radar radiation, preferably in a frequency range between 10 GHz and 10 THz.

In the measurement the radar transceiver 6 is adjusted in the guide means 7 in the vertical y direction, resulting in different beam paths as can be seen, in particular, from FIG. 3 showing, by way of example, certain vertical positions and the beam paths associated there with. In FIG. 1, on the right side in the vertical dotted line, the following relevant vertical points or, respectively, elevation points for the radar transceiver 6 are drawn in:
an upper point SO and a lower point SU in which the radar transmitting beam Th arrives straight at the exterior surface 4a so that these points SO and SU have a vertical distance of 2*r in relation to one another,
further, a middle point SM between the points SO and SU, in which, therefore, the radar transmitting beam Th arrives along the optical axis A-SM through the center point M; thus, the points SO and SU each have the vertical distance from SM corresponding to the external radius r,
as well as a current transmitting position S1 assumed be the transceiver 6 in this constellation, with the optical axis A-S1.

In the y adjustment the transceiver 6 arrives above the upper point SO and/or below the lower point SU and, thus, emits the radar transmitting beam Th through the empty measuring space 3 towards the reflector 8 which reflects the radar transmitting beam Th perpendicularly back to the transceiver 6 so that, according to the measuring diagram a) of FIG. 4, an empty measurement of the measuring space 3 is carried out, where the reflected radar beam Th is detected at a time tP0 which, therefore, has twice crossed a distance LX between the radar transceiver 6 and the reflector 8 in the longitudinal direction x, at the speed of light c0 in air. Thus, here, a time of flight of the peak P0 of tp0=(2*Lx)/c0 is measured. FIG. 2 shows such a measuring position above the point SO.

Subsequently, the transceiver 6 is adjusted downwards thereby arriving at the upper point SO firstly against the exterior surface 4a of the pipe 4, and subsequently upon further downwards adjustment passes through the exterior surface 4a into the ring-shaped wall 4c of the pipe 4, where, hereby, the radar beam Th is refracted according to Snellius' law of refraction. Thus, the radar transmitting beam Th passes through the wall 4c and exits the exterior surface 4a again at another y position. FIG. 3 shows an adjustment in the y direction with multiple vertical y positions and the corresponding beam paths. The radar transmitting beam Th is refracted in the upper half, i.e., above SM, according to the law of refraction on the exterior surface 4a inwards towards the center point M, where it does not hit the interior surface 4b in higher up y positions of the transceiver 6 and is refracted upwards again on the averted side, i.e., towards the reflector 8, upon exiting the exterior surface 4a. In the positions in which the radar transmitting beam Th subsequently hits the reflector 8 at a right angle of 90° it will be reflected back and travels in the same beam path back to the transceiver 6 so that its time of flight is detected. In other positions in which the radar transmitting beam Th subsequently hits the reflector 8 at not precisely a right angle of 90° it will continue in another beam path and generally no longer reach the transceiver 6, see the beam paths of FIG. 3.

As can be seen from FIG. 3, depending on the Y position, on the—in the measuring plane—circular exterior surface 4a different beam paths will result in the wall 4c and again outside between the pipe 4 and the reflector 8. Generally, a perpendicular reflection at the reflector 8, that allows for taking a measurement, is possible in the middle position SM and supplies the measuring diagram of FIG. 4 c), where the radar transmitting beam Th in the optical axis A-SM each passes perpendicularly through the exterior surface 4a, twice through the interior surface 4b and again the exterior surface 4a, where in each case partial reflection peaks according to FIG. 4c) occur at the times t1, t2, t3, and t4, then also forming a total reflection peak P2, reflected perpendicularly at the reflector 8 and travels back.

Furthermore, however, measurements are possible also at special positions S1 and S2, subsequently described in FIGS. 1, 2 as well as FIGS. 6, 7.

According to FIGS. 1 and 2, a measurement is made at the position S1 having a distance of ys from the middle point SM and, correspondingly symmetrical hereto, also the same distance ys below SM. Upon passing through the wall 4c of the pipe 4 a perpendicular reflection occurs at the reflector 8 so that the reflected radar transmitting beam Th can be detected again by the transceiver 6.

According to the invention, at position S1 a calculation of the geometric beam path is carried out with a determination of the relevant variables of the pipe 4.

Firstly, the external radius r of the pipe 4 is known;
To that end, it is possible, in principle, to carry out a mechanical measurement of the pipe 4 in advance, further, there will also be a measurement by the adjustment of the radar transceiver 6 in the vertical direction y so that the distance between the points SO and SM is measured as r and/or the diameter, i.e., the double external radius 2*r, accordingly between the points SO and SU. The measuring position SM can be determined by the typical measuring diagram, shown in FIG. 4 c), a total reflection peak P2 and four partial reflection peaks P2, P3, P4 and P5 on the exterior surface 4a and interior surface 4b, where, to that end, the exact times of flight are not relevant at first. In particular, it is also possible to carry out an averaging across the measurements between these points SO, SU, SM, as well as a continuous correction of these values upon reversing measuring.

In the course of the vertical adjustment of the radar transceiver 6 from SO downwards the radar transmitting beam Th then hits the exterior surface 4a and from there on is reflected inwards into the wall 4c so that the total reflection peak P0 vanished from the measuring signal as long as there is no perpendicular reflection on the reflector 8. Then, at the position S1 the diagram shown in FIG. 4b is measured with a single total reflection peak P1 at time tp1 so that this measurement can also, e.g., by distinguished from the measurement at SM. Die time of flight tp1 differs from the time of flight tP0 of the empty measurement by the time of flight inside the material of the pipe 4 that differs from the empty measurement. Further, the time of flight von tP1 of FIG. 4b differs from the time of flight of tP2 of FIG. 4c.

FIG. 2 shows the beam path in the vertical position of the emission point S1 in more detail: the radar transmitting beam Th travels from the emission point S1 along the optical axis A-S1 in a path x2 to the entry point E on the exterior surface 4a of the pipe 4, is refracted from there inwards towards the center point M and runs as axis s to the exit point A, and from there to the reflection point RA, at which it is reflected back perpendicularly and crosses this path again up to the emission point S1. In the representation of FIG. 2, the distance Lx between the emission point S1 and the reflector 8 is subdivided into three leg regions x1, x2, and x3, namely:
the leg region x2 from the emission point S to the entry point E,
subsequently, the leg region x3 resulting from the projection of the axis s on the optical axis A-S1 of the transceiver 6 running in the x direction. Hereby, in

FIG. 2. the point PX is shown as projection of the exit point A on the optical axis A-S1 so that x3 is the distance of E-PX,
the rear leg region x1 the length of which, therefore, corresponds to the stretch A-RA, with the reflection point RA on the reflector 8.

Thus, Lx=x1+x2+x3 is true. In FIG. 2, further, the beam path is specified at the entry point E by the entrance angle α (alpha) of the THz emission beam Th against the vertical radius r running perpendicularly through the exterior surface 4a and formed by the stretch E-M, and according to the exit angle β (beta) between the axis s and the vertical radius of the stretch E-M. Drawn in as δ (delta) is the angle between the axis s and the stretch E-PX, where γ (gamma) is the angle of the vertical radius E-M against the projection point PM which results as the vertical projection of the point E on the optical axis A-SM.

Thus, in this beam diagram or, respectively, this geometric drawing the following stretches are known:
Lx as the horizontal distance between the point S1 and the reflector 8, in particular, by virtue of the time-of-flight measurement in the empty space above SO,
the vertical height ys between S1 and SM from the active adjustment of the transceiver 6, and
the external radius r.

Unknown, however, are the distances x1, x2 and x3 as well as the axis s, and the refractive index n.

In this measurement at point S1 the time of flight of the radar transmission beam Th is measured and, in particular, the time-of-flight difference Δt to the empty measurement determined as Δt=tp1−tp0.

The time of flight tp1 of the THz transmission beam Th starting from the emission point S1 results from the distance x2 in air, the subsequent time of flight in the axis s in the material with the refractive index n of the pipe 4, and the subsequent distance x1 in air, and correspondingly back, i.e., with a factor of 2.

Now, these measurements can be used as follows to determine the refractive index n, even without prior knowledge of the distances x1, x2, x3 and s. Hereby, in particular, that fact is utilized that the refractive index n enters this diagram twice:
for one thing, according to the law of refraction, the angles α and β are fixed,
and furthermore, the time of flight in the axis s is determined by the refractive index n,
so that the value n enters these equations twice allowing for the refractive index n to be determined:

The time of flight tP0 in the empty space happens at light speed c0 across the double distance Lx, where

$$Lx = x 1 + x 2 + x 3 , \qquad ( equation 1 )$$

Accordingly, the time of flight tP1 contains the double value of the time of flight in the three distances S1-E, E-A, and A-RA, where the distances S1-E and A-RA in turn represent the distances x2 and x1,
i.e., the distances x1 and x3 are equal in these two measurements.

Thus, the measured, known time of flight delay Δt results, with
the speed of light cn=c/n inside the wall 4c,
the refractive index n as n=sina/sin β, by:

$$Δ t / 2 = c * s * n - c * x 3$$

Obviously, the angle δ (delta) results as the difference between α and β, see the angles at E, i.e.,

$$δ = α - β$$

further, the following applies to the right-angled triangle E, PX, A:

$$cos δ = x 3 / s ,$$

$$i . e . , x 3 = s * cos ( α - β )$$

$$i . e . ,$$

$$\frac{Δ t}{2 c} = s * n - x 3 = s * \frac{sin α}{sin β} - x 3 = s * ( \frac{sin α}{sin β} - cos ( α - β ) )$$

Thus, taking into account the addition theorem of cos (α−β):

$$\frac{Δ t}{2 c} = s * ( \frac{sin α}{sin β} - cos α cos β - sin α sin β ) \qquad ( equation 2 )$$

Further, for the right-angled triangle M, E, PM, it is true that at point M again the entrance angle α appears equal to the above entrance angle α because the optical axes A-S1 and A-SM run parallel in the x direction. Since the distance E-PM as ys is measured and known, and the following applies to the right-angled triangle M, E, PM:

$$sin α = ys / r \qquad ( equation 3 )$$

the angle of incidence a can be determined directly as

$$α = arcsin ( ys / r ) . \qquad ( equation 4 )$$

In equation 4 only the known measuring values ys and r appear so that alpha is known.

The triangle M, A, E has two equal legs r so that the following general geometric formular applies to this isosceles triangle

$$cos β = s / ( 2 r ) , i . e . , β = arccos ( s / ( 2 r ) ) , \qquad ( equation 5 )$$

Thus, in equation 2 the term cos β can be substituted by

$$cos β = s / ( 2 r ) ,$$

further, the term sin β substituted by

$$sin β = sin ( arc cos ( ( s / ( 2 r ) ) )$$

thus, in equation 2 the following are known: the measured value Δt, the speed of light c=c0 in air, as well as a and therewith sin α, cos α,
so that only the variables s and B remain, whereby, according to equation 5, even β can be substituted by s and r,
so that in equation 2 only the variable s remains and can be calculated using the known values of c, ys, r, Δt.

In other words: This results in the system of equations 2 and 5, i.e., therefore, two equations, from which the two unknowns s and β can be determined.

Hereby, in equation 2 the result is a value that can no longer be described directly, but in equation 2 e.g., Taylor series or, respectively, power series can be used for the functions sin β and cos β, i.e.,

$$\begin{matrix}sin x = {\sum }_{n = 0}^{∞} {( - 1 )}^{n} \frac{{x}^{2 n + 1}}{( 2 n + 1 ) !} = \frac{x}{1 !} - \frac{{x}^{3}}{3 !} + \frac{{x}^{5}}{5 !} ∓ … \\ cos x = {\sum }_{n = 0}^{∞} {( - 1 )}^{n} \frac{{x}^{2 n}}{( 2 n ) !} = \frac{{x}^{0}}{0 !} - \frac{{x}^{2}}{2 !} + \frac{{x}^{4}}{4 !} ∓ …\end{matrix}$$

These Taylor series lead to an approximation of β with infinite accuracy, so that a determination of β by a computer is possible-even at low computing power.

Thus, with a known β, n=sin α/sin β can be calculated directly.

Thus, when establishing a geometric structure known as such or, respectively, a geometric beam path with beam paths known in principle, in particular, according to FIG. 2, with the characteristics of a perpendicular incidence at point RA on the reflector 8, using two characteristics of the refractive index n, namely
the relation to a and B according to the law of refraction, as well as
the change of the speed of light in the material depending on the refractive index n,
the refractive index n can be determined directly by means of the measured values time of flight delay Δt, external radius r and vertical position ys.

Thus, in the method described—in contrast to the initially mentioned method of WO 2016/139155 A1—for a determination of the refractive index it is not necessary or provided to carry out the beam path through both wall regions or, respectively, a beam path through the interior space of the measured object, so that this determination procedure may occur, in particular, also in addition to other determinations, or instead of other determinations.

Thus, the method according to the invention includes the following steps:
providing a measuring device with a radar transceiver 6, guide means 7 and reflector 8
guiding a measured object 4 through the measuring space 3 and adjusting the radar transceiver 6 using the guide means 7 in a vertical direction y,
measuring times of flight in at least
   one vertical position SO outside the measured object 4, i.e., as empty measurement of the measuring space 3 outside the measured object 4,
   in one vertical position S1 in which the radar transceiver 6 supplies one signal with only a single total reflection peak P1, without additional reflection peaks or partial reflection peaks at the interior surface 4b and exterior surface 4a, while determining of the vertical position ys of S1 and while measuring the time of flight tP1
determining an external radius r of the measured object 4, e.g., from the vertical adjustment of the radar transceiver 6 while evaluating the measured signal,
subsequent mathematical calculation of n from the measurements.

Thus, r and n are known, the wall thicknesses, i.e., the difference of external radius r and internal radius ri can be drawn from a measurement at point SM, which distinctly results from the measuring signal as signal with partial reflections at 4a and 4b.

Thus, according to the invention, also according to FIG. 5 according to the method of DE 10 2020 120 547 A1, a measurement can be carried out, e.g., when an interior reflection peak at an interior surface 4b is missing, because with a known refractive index n the position of the wall surface and the corresponding layer thicknesses can be estimated on the basis of the empty measurement and the transmission measurement at the points S1 and SM even when there is no reflection at a boundary surface.

Thus, upon adjusting the transceiver 6 starting from the upper position SO firstly the position S1 is reached in which, according to FIGS. 1, 2, the total reflection peak P1 is measured. When the transceiver 6 is subsequently further adjusted downwards vertically in the Y direction, the axis S running inside the wall 4c is also adjusted downwards accordingly. Thus, the entry point E changes, thereby decreasing the angle γ because the axis s is flatter. Thus, subsequently—even before the middle position SM is reached—the position S2 of FIG. 6 is generally reached in which the axis s, i.e., the radar transmitting beam Th refracted in the pipe 4—hits the interior surface 4b thereby being totally reflected at a flat angle, i.e., the total reflection criterion of the transition from the dense medium of the pipe 4 with the high refractive index n against the air of the interior space with the refractive index n0=1 is fulfilled.

In the position S2 of FIGS. 6 and 7 there is a symmetrical path, according to which the radar transmitting beam Th from the entry point E on the axis s reaches the upper point IR of the interior surface 4b in such a manner that after total reflection it is symmetrically reflected upwards towards the exit point A. Thus, the geometric formation is symmetric with respect to the vertical line from the center point M—to the upper point IT of the exterior surface 4a.

Thus, the radar transmitting beam Th runs starting from point S2 initially in the X direction up to the entry point E into the exterior surface 4a, where it is refracted inwards according to Snellius' law of refraction, and runs as axis s through the wall 4c until the axis s reaches the upper point IR of the interior surface 4b from where it again symmetrically runs as axis s up to the exit point A, where the exit point A and the entry point E lie at the same vertical height S2, whereupon the radar transmitting beam Th continues to the exit point A again in the X direction and hits the reflector 8 perpendicularly so that it is re-reflected here and returns in the same beam path so that in S2 a total reflection peak without partial reflection peaks is measured.

Thus, the position S2 can also be distinguished from the measurement at position S1 because it happens later at a lower Y position than the first position S1 in FIGS. 1, 2.

The special geometric arrangement of position S2 in turn allows for a direct determination of the refractive index n because the refractive index again enters this optical arrangement twice:
For one thing, by virtue of Snellius' law of refraction, the refractive index n enters into the geometric relation between the angles alpha and beta.

For another, the refractive index n determines the time-of-flight delay,
so that the refractive index n can again be determined from these two relations:
   I. Determination from Snellius' Law of Refraction:

The distance ys, i.e., the vertical distance of point S2 from the middle position SM, is known by virtue of the adjustment of the transceiver 6, where, in FIGS. 6, 7, ys corresponds to the distance E-PM as well as the distance IM-M.

Furthermore, the external radius r is known also from one of the possible previous measurements, i.e., again as a mechanical measurement, optical measurement using laser, ultrasound and/or by the vertical adjustment of the transceiver 6 between the positions SO, SM and SU.

Thus, in the triangle E, PM, M, or, respectively, the triangle identical or similar there with E, IM, M, the hypotenuse r and the leg ys are known.

Hereby, again, the entrance angle α, due to the parallel beam paths or, respectively, parallel axes at the points S2 and SM, is formed also at the center point M, as can be seen in FIG. 6, so that the triangle E, PM, M, or, respectively, the triangle identical there with M, IM, E, is clearly determined allowing for the entrance angle α to be calculated directly from the measured variable ys and r as

$$sin α = ys / r .$$

Thus, the entrance angle α is known,

Under the law of refraction sin α/sin β=n,

$$so that β = arc sin ( sin α / n ) \qquad ( equation 6 )$$

determines a first relation between B and n so that, with a known entrance angle α, the exit angle β is a direct function of the refractive index n, i.e., β=f (n).
Ii. Determination from the Time-of-Flight Measurement

The radar transmitting beam Th runs from S2 to E, from where it will reach the exterior surface 4a, again at an entrance angle α relative to the perpendicular, and enters the wall 4c at an entrance angle β relative to the perpendicular radius r, runs as axis s up to the reflection point IR, with a subsequently symmetric path to the exit point 4. In this measurement at point S2, again at first the time-of-flight difference Δt compared to the empty measurement above SO is determined. Corresponding to the explanations relating to FIGS. 1, 2, the distance Lx, i.e., the transceiver distance of the transceiver 6 to the reflector 8, can be subdivided into partial distances x1, x2, xs, i.e., the partial distances
the partial distance x1=S2-E from the emission point S2 to the entry point E,
the partial distance x3=E-A from the entry point E to the exit point A, where, thus, x3 corresponds to twice the distance xs=E-IT, i.e.,

$$x3 = 2 * ( xs )$$

as well as the partial distance x2 from the exit point A to the reflector 8.

Hereby, the radar transmitting beam Th again identically travels the partial distances x1 and x2 at both positions in the empty measurement at SO as well as the measurement at S2 so that the time-of-flight difference Δt or, respectively, time-of-flight delay again can be associated with the distance inside the wall 4c, i.e., therefore, the measured, known time of flight delay Δt results as
the speed of light cn=c/n inside the wall 4c,
the refractive index n with n=sin α/sin β, by:

$$\begin{matrix}Δ t / 2 = 2 * ( c * s * n - c * xs ) \\ Δ t = 4 * c ⋆ ( s * n - xs )\end{matrix}$$

This equation of FIGS. 6, 7 differs from FIG. 2 by the factor 2, because, compared to FIG. 2, half the distances are designated as s and xs.
xs is known from

$$\begin{matrix}\begin{matrix}= both & xs = r * cos α\end{matrix} \\ = and the Pythagoras equation {xs}^{2} + {ys}^{2} = {r}^{2}\end{matrix}$$

because ys, r, a are known.

Thus, the time-of-flight equation results as xs=r*cos α

$$Δ t = 4 * c ⋆ ( s * n - r * cos α ) \qquad ( equation 7 )$$

where in equation 6 only s and n are unknown.

Hereby, a geometric relation between s and β can be seen:

In the triangle E, IM, IR, the angle δ is geometrically determined by xs and s as

$$cos δ = xs / s ,$$

also results β=α−δ
i.e.,

$$s = xs / ( cos δ ) = xs / cos ( α - β )$$

with known values for xs, a.

Thus, it results by insertion into the equation 7:

$$Δt = 4 * c ⋆ ( ( xs * n / cos ( α - β ) ) - r * cos α ) \qquad ( equation 8 )$$

the second relation of β and n,
because the further variables are known.

Thus, it is possible to determine both B and n, from the law of refraction for one thing and the time-of-flight calculation for another, in which the refractive index enters as time-of-flight delay, i.e., equation 6 for one thing and equation 8 for another.

Again, there results a system of equations made of two equations for the variable n and β, which, therefore, can be clearly solved, in particular, using a calculating system or, respectively, Taylor expansion. It is also apparent that small deformations of the interior surface 4b have no great influence because, for one thing, such deformations, in particular, in lateral regions of the interior space or, respectively, the interior surface 4b appear as sagging but not very much in the upper region and lower region,
also such geometric formation can also be carried out—mirrored vertically—at the corresponding geometric lower point, with the negative distance
ys to the middle point SM, and here a determination or, respectively, verification can be carried out.

Thus, in this embodiment, it is further possible, to determine also the wall thickness between the points IT and IR purely geometrically, i.e., without any further measurement, as sum of
a) the distance between IT and IM and
b) a) the distance between IM and IR:
   with respect to a): a) the distance ds of the points IM, IR can be determined from the triangle E, IR, IM:

Hereby, in the geometric formation the distances xs, s are known because, when n and a are known β is also known, furthermore, the angle δ is also known as the difference between α also β.

Thus, the distance ds of the points IM, IR can be determined from the triangle E, IR, IM, with known s and xs, according to the relation of Pythagoras ds²+xs²=s²
or from ds=xs*cos δ
with respect to b) further, the distance dss between the points IM, IT is known directly from the vertical adjustment of the transceiver 6 from point SO to S2. However, a further result is, since the distance IT-M corresponds to the external radius r, form

$$dss = r - y s .$$

Thus, the wall thickness between the points IT and IR results as wd=ds+dss.

Moreover, the internal radius ri, i.e., the distance between the points M and IR, results as difference

$$r i = y s - d s$$

or, respectively, ri=r−wd.

Thus, in the embodiment of FIG. 6, in the measuring position S2 a complete determination of the pipe 4, i.e., both the refractive index n, and the wall thickness wd, as well as the internal radius ri of the upper is possible, without measuring partial reflection peaks, as it is done at position SM.

This measurement of the external radius r, the lower wall thickness and the internal radius ri can also be carried out accordingly at the lower position of S2, i.e., with a (negative) distance ys below SM.

FIG. 8 shows the positioning of one or mare transceiver(s) 6-1 and 6-2, as well as, accordingly, also 6-3 and 6-4, at perpendicular positions relative to the pipe 4. Because the distance of the two transceivers 6-1 and 6-2 in relation to one another is known by the positioning as such, here it is also possible to use a measurement of the distance of the exterior surface 4a to the transceivers 6-1, 6-2 to determine the exterior diameter r. Hereby, the distances d6-1 and d6-2 in air can be measured, i.e., even without knowing the refractive index. Accordingly, the external radius r between the transceivers 6-3 and 6-4 can be determined.

FIG. 8 shows a further additional embodiment of the determination of the refractive index n and further properties of the pipe 4 by means of a suitable geometric arrangement and adjustment of transceivers. Hereby, however, the transceiver 6 is pivoted, where it may additionally be adjusted in one direction.

Hereby, a transceiver 6 pivots about a swing angle ρ so that again, successively, the particular positions of the previous FIGS. 1,2 as well as FIGS. 6, 7 are assumed, where a reflector can be positioned behind the pipe 4 or a reflector 108 for receiving partial reflection peaks at the boundary surfaces 4a and 4b. Hereby, the reflector 108 may, in particular, also pivot so that the boundary surfaces may be covered by the combined and/or successive pivot movements. Hereby, e.g., even multiple reflectors 108 may be utilized.

Thus, this geometric arrangement, i.e., with swiveling and determination of the swing angle of the transceiver 6 and possibly the reflector 8 and/or of reflectors 108, instead of or in addition to the vertical adjustment in the Y direction, also allows for a corresponding geometric determination and, with measuring the time-of-flight difference, a determination of the refractive index n so that again a full measuring of the pipe 4 is carried out. In particular, the transceiver 6 can be swiveled such that at reaches the symmetric middle position according to SM in which its optical axis A6 runs perpendicular through the center point M and therewith through the wall surfaces 4a, 4b. Furthermore, positions S1 and S2 corresponding to those according to the embodiments of Figures S1, S2, and S6, S7 are reached.

### LIST OF REFERENCE NUMERALS

1 radar measuring arrangement
2 radar measuring device
3 measuring space
4 measured object, pipe
4a exterior surface, exterior wall
4b interior surface, interior wall
4c wall
6 radar transceiver
7 guide means
8 reflector, mirror
10 controller and evaluation means
108 reflectors
n refractive index
S axis
wd2 wall thickness
Si measuring signal
Th radar transmitting beam
A exit point
E entry point
P1 total reflection peak
M center point
X longitudinal direction, direction between radar transceiver 6 and reflector 8
y vertical direction, adjusting direction of the radar transceiver 6
Z object adjusting direction, transport direction of the pipe 4
r external radius
ri internal radius
tp1 time of flight
tp0 empty time of flight
Δt time-of-flight difference, time-of-flight delay
c0 light speed
LX receiver distance of the radar transceiver 6 to the reflector 8
x1, x2, x3 leg regions of Lx
A, E, M, PM, SM, PX, SO, SU, geometric points in FIG. 1, 2, 6
RA geometric points in FIG. 2, reflection point
IT, IR, IM geometric points in FIG. 6
S1 measuring position of FIG. 1, 2
S2 measuring position of FIG. 6
α entrance angle
β exit angle
γ, δ, ρ further angles

The invention therefore comprises in particular the following clauses:

### Clause 1

Method for measuring a tubular measured object, in particular after extrusion of the tubular measured object, said method including the following steps: guiding the tubular measured object in an object adjusting direction through a measuring space between a radar transceiver and a reflector,
emitting a radar transmitting beam from the radar transceiver along its optical axis in a transverse direction through the measuring space towards the reflector and back towards the radar transceiver, while determination an empty time of flight,
adjusting the radar transceiver in an adjusting direction which preferably runs perpendicular to the transverse direction, and emitting and receiving the radar transmitting beams at various adjustment positions,
upon detecting a measurement signal comprising:
   a total reflection peak at a time-of-flight shift in relation to the empty measurement, and
   no further partial reflection peaks, measuring the adjustment position and the time-of-flight shift,
measuring an external radius of the tubular measured object, and
determining the refractive index of the tubular measured object from the values recorded.

### Clause 2

Method according to clause 1, wherein the adjusting direction of the radar transceiver is linear.

### Clause 3

Method according to clause 1, wherein the adjusting direction of the radar transceiver is perpendicular to the object adjusting direction and/or to an optical axis of the radar transceiver.

### Clause 4

Method according to clause 1, wherein the adjustment of the radar transceiver is, at least in part, a swiveling adjustment.

### Clause 5

Method according to clause 1, wherein a position of the radar transceiver is assumed and measured in which the radar transmitting beam passes through a wall of the measured object without reflection on an interior surface, while detecting a total reflection peak.

### Clause 6

Method according to clause 1, wherein a position of the radar transceiver is assumed and measured in which the radar transmitting beam passes through a wall of the measured object without reflection on an interior surface, while detecting a total reflection peak.

### Clause 7

Method according to clause 1, wherein a position of the radar transceiver is assumed and measured in which the radar transmitting beam passes at an entry point through an exterior surface of the measured object, with subsequent reflection, in particular total reflection, on an interior surface and subsequent passage through an exit point towards the reflector, while detecting a total reflection peak, in particular with symmetrical beam after reflection on the inner surface.

### Clause 8

Method according to clause 1, wherein the refractive index is determined from the system of equations

$$\frac{Δ t}{2 c} = s * ( \frac{sin α}{sin β} - cos α cos β - sin α sin β ) \qquad ( equation 2 )$$

$$α = arc sin ( ys / r ) \qquad ( equation 4 )$$

$$β = arc cos ( s / ( 2 r ) ) \qquad ( equation 5 )$$

with the variable
delta t: time-of-flight shift,
ys: vertical position,
r: external radius
c: speed of light in air.

### Clause 9

Method according to clause 1, wherein the external radius is determined according to one or more of the following measuring method(s):
mechanical measurement,
optical measurement,
ultrasound,
additional radar sensors in another geometric arrangement,
adjustment of the radar transceiver in the vertical direction while receiving the measurement signal, where the external radius is determined as a vertical distance according to one or more of the following measuring method(s)
between an upper outer point at the upper edge of the tubular measured object and the opposite lower outer point and/or
between a middle point at which the radar transmitting beam passes perpendicularly through the exterior surface and interior surface of the tubular measured object, and one of the outer points.

### Clause 10

Method according to clause 1, wherein the radar transmitting beam is emitted in the frequency range between 10 GHz and 50 THz, in particular, 10 GHz and 10 THz, in particular, 20 GHz or 50 GHz and 3 THz.

### Clause 11

Method according to clause 1, wherein the radar transmitting beam is emitted according to one or more of the following method(s):
by frequency modulation, FMCW radar, pulsed radiation, direct time-of-flight measurement

### Clause 12

Method according to clause 1, wherein the radar transceiver is adjusted, in particular reversed, on a guide means continuously in the adjusting direction.

### Clause 13

Method according to clause 1, wherein a front wall thickness of a front wall region before the THz transceiver, and/or a rear wall thickness of a rear wall region before the reflector is determined from the determined refractive index and a middle measurement at a middle position while measuring times of partial reflection peaks on the exterior wall and the interior wall.

### Clause 14

Radar measuring device for measuring a tubular measured object, the radar measuring device comprising:
a radar transceiver for emitting a radar transmitting beam along its optical axis in a transverse direction,
a guide means for adjusting the radar transceiver in an adjusting direction,
a reflector provided spaced apart from the radar transceiver in a longitudinal direction,
where a measuring space between the reflector and the radar transceiver is formed, and
a controller and evaluation unit detecting the time of flight of the radar transmitting beam from the radar transceiver to the reflector and back to the radar transceiver and relating the time-of-flight measurements to the positions of the radar transceiver,
the controller means being adapted to determine a refractive index of the material of the measured object from
   at least one empty measurement with determination of an empty time of flight,
   an external radius of the measured object,
   and at least one wall region transmission measurement in a vertical measuring position of the radar transceiver, in which wall region transmission measurement the measuring signal comprises or has
      only one total reflection peak occuring,
      without partial reflection peaks or no partial reflection peaks of the exterior surface and the interior surface of the tubular measured object, while determining a time-of-flight delay in the vertical measuring position compared to the empty measurement.

### Clause 15

Radar measuring device according to clause 14, wherein the adjusting direction is linear and runs perpendicular to the optical axis, and the controller and evaluation unit relates the time of flight of the radar transmitting beam from the radar transceiver to the reflector and back to the vertical positions of the radar transceiver

### Clause 16

Radar measuring device according to clause 14, wherein the guide means is adapted to swivel the radar transceiver.

1. A method for measuring a tubular measured object,
said method including the following steps:
guiding the tubular measured object in an object adjusting direction through a measuring space between a radar transceiver and a reflector,
emitting a radar transmitting beam from the radar transceiver along its optical axis in a transverse direction through the measuring space towards the reflector and back towards the radar transceiver, while determination an empty time of flight,
adjusting the radar transceiver in an adjusting direction, and emitting and receiving the radar transmitting beams at various adjustment positions,
upon detecting a measurement signal comprising:
a total reflection peak at a time-of-flight shift in relation to the empty measurement, and
no further partial reflection peaks,
measuring the adjustment position and the time-of-flight shift,
measuring an external radius of the tubular measured object, and
determining the refractive index of the tubular measured object from the values recorded.

2. The method according to claim 1, wherein the adjusting direction of the radar transceiver is linear.

3. The method according to claim 1, wherein the adjusting direction of the radar transceiver is perpendicular to the object adjusting direction and/or to an optical axis of the radar transceiver.

4. The method according to claim 1, wherein the adjustment of the radar transceiver is, at least in part, a swiveling adjustment.

5. The method according to claim 4, wherein the swing angle runs perpendicular to the object adjusting direction.

6. The method according to claim 1, wherein a position of the radar transceiver is assumed and measured in which the radar transmitting beam passes through a wall of the measured object without reflection on an interior surface, while detecting a total reflection peak.

7. The method according to claim 1, wherein a position of the radar transceiver is assumed and measured in which the radar transmitting beam passes at an entry point through an exterior surface of the measured object, with subsequent reflection on an interior surface and subsequent passage through an exit point towards the reflector, while detecting a total reflection peak.

8. The method according to claim 1, wherein the refractive index is determined from the system of equations
$$\frac{Δ t}{2 c} = s * ( \frac{sin α}{sin β} - cos α cos β - sin α sin β ) \qquad ( equation 2 )$$
$$α = arc sin ( ys / r ) . \qquad ( equation 4 )$$
$$β = arc cos ( s / ( 2 r ) ) , \qquad ( equation 5 )$$
with the variable
delta t: time-of-flight shift,
ys: vertical position,
r: external radius
c: speed of light in air.

9. The method according to claim 1,
wherein the external radius is determined according to one or more of the following measuring method(s):
mechanical measurement,
optical measurement,
ultrasound,
additional radar sensors in another geometric arrangement,
adjustment of the radar transceiver in the vertical direction while receiving the measurement signal, where the external radius is determined as a vertical distance according to one or more of the following measuring method(s):
between an upper outer point at the upper edge of the tubular measured object and the opposite lower outer point and/or
between a middle point at which the radar transmitting beam passes perpendicularly through the exterior surface and interior surface of the tubular measured object, and one of the outer points.

10. The method according to claim 1, wherein the radar transmitting beam is emitted in the frequency range between 10 GHz and 50 THz, in particular, 10 GHz and 10 THz, in particular, 20 GHz or 50 GHZ and 3 THz.

11. The method according to claim 1, wherein the radar transmitting beam is emitted according to one or more of the following method(s):
by frequency modulation, FMCW radar, pulsed radiation, direct time-of-flight measurement.

12. The method according to claim 1, wherein the radar transceiver is adjusted on a guide means continuously in the adjusting direction.

13. The method according to claim 1, wherein a front wall thickness of a front wall region before the THz transceiver, and/of a rear wall thickness or a rear wall region before the reflector is determined from the determined refractive index and a middle measurement at a middle position while measuring times of partial reflection peaks on the exterior wall and the interior wall.

14. A radar measuring device for measuring a tubular measured object, the radar measuring device comprising:
a radar transceiver for emitting a radar transmitting beam along its optical axis in a transverse direction,
a guide means for adjusting the radar transceiver in an adjusting direction,
a reflector provided spaced apart from the radar transceiver in a longitudinal direction,
where a measuring space between the reflector and the radar transceiver is formed, and
a controller and evaluation unit detecting the time of flight of the radar transmitting beam from the radar transceiver to the reflector and back to the radar transceiver and relating the time-of-flight measurements to the positions of the radar transceiver,
the controller means being adapted to determine a refractive index of the material of the measured object from
at least one empty measurement with determination of an empty time of flight,
an external radius of the measured object,
and at least one wall region transmission measurement in a vertical measuring position of the radar transceiver.
in which wall region transmission measurement the measuring signal comprises
only one total reflection peak,
no partial reflection peaks of the exterior surface and the interior surface of the tubular measured object,
while determining a time-of-flight delay in the vertical measuring position compared to the empty measurement.

15. The radar measuring device according to claim 14, wherein the adjusting direction is linear and runs perpendicular to the optical axis, and
the controller and evaluation unit relates the time of flight of the radar transmitting beam from the radar transceiver to the reflector and back to the vertical positions of the radar transceiver.

16. The radar measuring device according to claim 14, wherein the guide means is adapted to swivel the radar transceiver.
